(19) United States
(12) Patent Application Publication
(10) Pub. No.: US 2025/0164029 A1
(43) Pub. Date: May 22, 2025

(54) METHOD FOR CONTROLLING AN ELECTROMAGNETICALLY CONTROLLABLE GAS VALVE, AND CONTROL DEVICE

(71) Applicant: Robert Bosch GmbH, Stuttgart (DE)

(72) Inventors: Fabian Fischer, Waiblingen (DE); Marco Beier, Rudolstadt (DE); Oezguer Tuerker, Gerlingen (DE); Thomas Gann, Boeblingen (DE); Torsten Burock, Vaihingen An Der Enz (DE)

(21) Appl. No.: 18/835,136

(22) PCT Filed: Oct. 14, 2022
(86) PCT No.: PCT/EP2022/078657

§ 371 Date: Aug. 1, 2024

(30) Foreign Application Priority Data
Feb. 28, 2022 (DE) 10 2022 202 027.8

(51) Int. Cl. F16K 31/06

(52) U.S. Cl. CPC F16K 31/0675

(57) ABSTRACT

A method for controlling an electromagnetically controllable gas valve. In order to open a seal seat, a solenoid coil acting on an armature is supplied with current so that a valve member interacting with the seal seat is lifted out of the seal seat by the armature and, in order to close the seal seat, the current supply to the solenoid coil is terminated so that the valve member is returned into the seal seat by the spring force of a closing spring, wherein the return of the valve member into the seal seat causes the armature to disengage from the valve member and perform a free stroke. A braking current is applied to the solenoid coil during the closing and, depending on the direction of movement of the armature, the current supply to the solenoid coil is interrupted and/or the current level is varied. A control device is also described.

### FIELD

The present invention relates to a method for controlling an electromagnetically controllable gas valve. Such a gas valve is also called a gas dosing valve or gas injector. The gas may in particular be a gaseous fuel, for example hydrogen, which is required to operate an internal combustion engine or a fuel cell system.

In addition, the present invention relates to a control device configured to perform steps of the method according to the present invention.

### BACKGROUND INFORMATION

Many gas valves for dosing gaseous fuels are described in the related art. They are often controlled electromagnetically. In this case, a solenoid coil is provided, which acts on a reciprocating armature, which can be coupled to a valve member for opening and closing the gas valve or itself forms the valve member.

Due to the lack of hydraulic damping, strong closing rebounds can easily occur in the case of a gas valve. These rebounds result in a considerable additional amount in the injection and in severe seat wear. In addition, closing rebounds are accompanied by undesirable noise development. For the operation of the gas valve, a robust measure for dampening the closing process should therefore be found.

### SUMMARY

An object of the present invention is to provide a robust measure for dampening the closing process. In particular, the impact speed when closing the gas valve should be reduced so that, on the one hand, an increase in robustness may be achieved and, on the other hand, reopening of the gas valve due to closing rebounds is avoided.

In order to achieve the object, the method having features of the present invention is provided. Advantageous example embodiments and developments of the present invention can be found in the disclosure herein. In addition, a control device for performing steps of the method is specified according to the present invention.

In the method according to an example embodiment of the present invention for controlling an electromagnetically controllable gas valve, for opening a seal seat, a solenoid coil acting on an armature is supplied with current so that a valve member interacting with the seal seat is lifted out of the seal seat by the armature. For closing the seal seat, the current supply to the solenoid coil is terminated so that the valve member is returned into the seal seat by the spring force of a closing spring, wherein the return of the valve member into the seal seat causes the armature to disengage from the valve member and perform a free stroke. According to the present invention, a braking current is applied to the solenoid coil during the closing and, depending on the direction of movement of the armature, the current supply to the solenoid coil is interrupted and/or the current level is varied.

The applied braking current decelerates the movement of the armature so that the armature reaches its stop at a reduced speed. As a result, the impact impulse at the stop is reduced or dampened. Accordingly, the robustness of the gas valve increases in the area of the stop or of the contact surfaces forming the stop. Moreover, strong closing rebounds are avoided, which lead to the gas valve reopening after the closing. In this context, the free stroke of the armature relative to the valve member also proves to be advantageous.

Since the braking current in the method according to the present invention is applied depending on the direction of movement of the armature, the armature can be decelerated significantly more effectively than with a continuous current supply. This is because the braking effect desired by means of the magnetic force is achieved when the armature moves in the direction of the stop. If the direction of movement of the armature reverses due to closing rebounds after reaching the stop, the magnetic force has the opposite effect. This means that the armature is not decelerated but accelerated. By means of the proposed method, this can be counteracted by interrupting the current supply to the solenoid coil and/or varying the current level depending on the direction of movement of the armature. This ultimately leads to the braking current being applied in a pulsating manner.

A pulsating braking current application according to the method according to an example embodiment of the present invention requires knowledge of the direction of movement of the armature. In a development of the present invention, it is therefore provided that a control frequency analysis of the current signal and/or voltage signal is carried out in order to detect the direction of movement of the armature. This is because the direction of movement of the armature influences the control frequency. The influence is due to the fact that as the inductance of the solenoid coil increases, the smaller the working air gap between the armature and a pole body of the magnetic circuit becomes. As a result, the control frequency increases. In contrast, as the working air gap increases, the induced voltage leads to an increase in current. Depending on the speed of the armature, either no current control or a current control with a low control frequency takes place in this phase.

According to an example embodiment of the present invention, preferably, a braking current is only applied when the armature moves in the direction of a stop and/or reversal point remote from the seal seat, so that a braking current phase is followed by a current supply pause. This means that the current supply is interrupted at least once, namely, when the armature moves in the other direction or in the direction of the valve member after reaching the stop and/or reversal point. The current supply pause prevents the armature from being accelerated in the direction of the valve member and possibly lifting it out of the seal seat again so that the gas valve opens again. If the armature changes its direction of movement several times due to closing rebounds, braking current phases and current supply pauses ideally alternate.

Furthermore, according to an example embodiment of the present invention, it is therefore provided that the current supply pause is followed by a new braking current phase when the armature has reached a stop and/or reversal point close to the seal seat.

According to an example embodiment of the present invention, if braking current phases and current supply pauses alternate, a current level in each further braking current phase is furthermore preferably selected to be at most equal to the current level of the preceding braking current phase. This is because, with each further reversal of the direction of movement, the speed of the armature is also reduced so that the braking effect can likewise be less. Preferably, the current level is therefore lowered in each further braking current phase.

According to an example embodiment of the present invention, alternatively or in addition to an interruption of the braking current, the current level of the braking current can be varied depending on the direction of movement of the armature. A braking current phase is then not followed by a current supply pause, but by a further braking current phase, which is, however, at a different current level. For example, depending on the direction of movement of the armature, the current level can be lowered to such an extent that the magnetic force of the solenoid coil has no or only a very slight influence on the movement of the armature. This is advantageous when the armature has already reached its stop and is moving from the stop back in the direction of the valve member. Since the magnetic force is correspondingly small, the armature is not accelerated or accelerated only very slightly so that undesirable re-injection does not occur.

Consequently, the current level of the braking current is preferably reduced when the armature has reached a stop and/or reversal point remote from the seal seat. Further preferably, the current level of the braking current is increased again when the armature has reached a stop and/or reversal point close to the seal seat. The armature, which is again moving in the direction of the stop and/or reversal point remote from the seal seat, is then decelerated again in its movement by means of magnetic force.

Maintaining the current supply at a very low current level in the phases in which the armature moves in the direction of the valve member when the gas valve is already closed has the advantage that the braking current can be used as a sensor current. In particular, the direction of movement of the armature can be detected by means of the sensor current.

In the method according to an example embodiment of the present invention, the braking current is not applied at the beginning of a closing process, but only toward the end of a closing process, in order not to impair the dynamics of the closing process. In any case, the braking current is applied before the gas valve is closed, i.e., before the time at which the valve member is returned into the seal seat. This is because the proposed method can then be used to simultaneously realize closing time recognition.

For this purpose, according to an example embodiment of the present invention, the current level is preferably increased continuously during a first braking current phase until a first target level of, for example, 4 A to 10 A is reached. When the first target level is reached, a freewheeling phase is initiated, in which a new target level for the braking current is defined, which is at most identical to the first target level. The freewheeling phase is terminated when the armature reverses its direction of movement, wherein an extinction voltage is preferably applied to terminate the freewheeling phase.

Reaching the high first target level ensures that a sufficiently high magnetic force for decelerating the movement of the armature is generated. This lowers the risk of closing rebounds. At the same time, the robustness and metering accuracy of the gas valve increase. The subsequent freewheeling phase can then be used for closing time recognition, wherein the time at which the valve member is returned into the seal seat, i.e., the gas valve actually closes, is detected. Since the armature disengages from the valve member and performs a free stroke at the end of an injection process, the movement of the armature does not correlate with that of the valve member. The armature movement therefore cannot be used to detect the closing time.

According to an example embodiment of the present invention, preferably, the closing time of the gas valve is detected by evaluating the current curve and/or voltage curve during the freewheeling phase. This is possible since, when the gas valve closes, the armature disengages from the valve member and continues to move or performs a free stroke. As soon as the armature has disengaged from the valve member, the acceleration of the armature that is caused by the spring force of the closing spring abruptly ceases, which causes a great change in speed. This not only is recognizable by a kink in the speed curve but can also be read from the current signal and/or voltage signal.

By knowing the closing time, changes can be recognized and, if necessary, the control of the gas valve can be adapted to the changes. In this way, a control loop for controlling the closing time can be realized. The closing time recognition can accordingly further increase the metering accuracy of the gas valve.

A boost voltage or a battery voltage can be used as the voltage source for the braking current to be applied. In mobile applications, the battery voltage of a vehicle battery may be used, for example.

In order to achieve the object mentioned at the beginning, a control device for controlling a gas valve is also provided according to the present invention. The control device is configured to perform steps of a method according to the present invention. In particular, a pulsating braking current can be applied to the solenoid coil of the gas valve by means of the control device. Furthermore, the control device can be used to evaluate the current curve and/or voltage curve in order to detect the direction of movement of the armature and/or the closing time of the gas valve.

The present invention and its advantages are explained in more detail below with reference to the figures.

### DETAILED DESCRIPTION OF EXAMPLE EMBODIMENTS

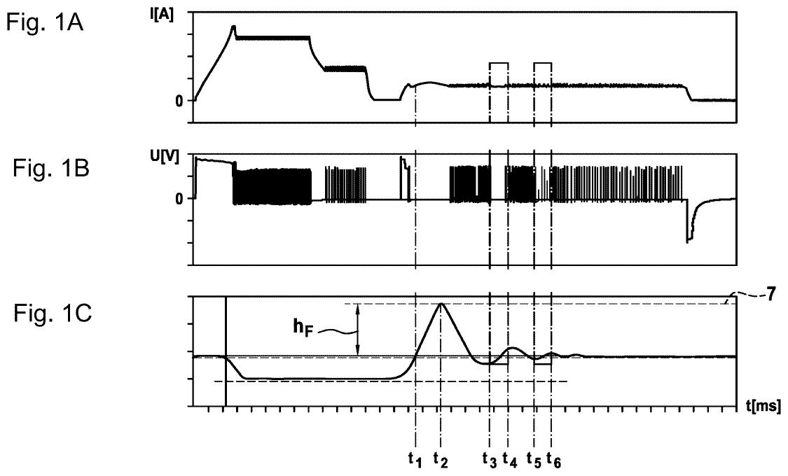

FIGS. 1A-1C shows diagrams for the graphical representation of (FIG. 1A) the current curve, (FIG. 1B) the voltage curve, and (FIG. 1C) the armature stroke during an opening and closing process of an electromagnetically controlled gas valve,

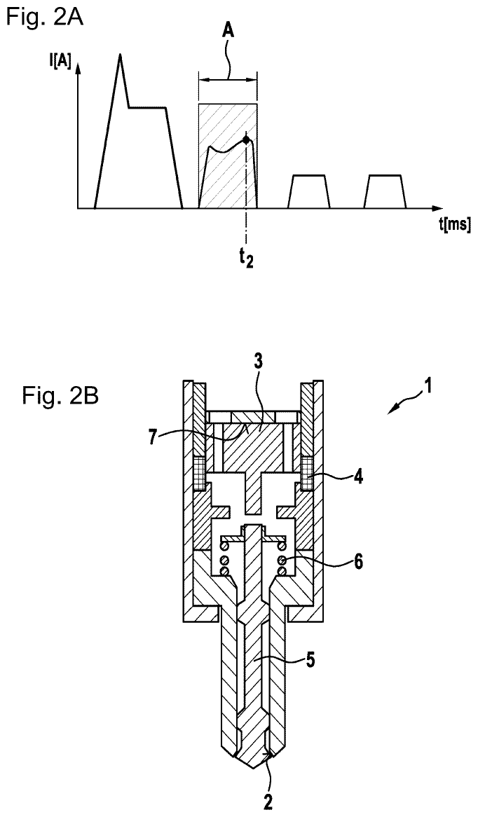

FIGS. 2A and 2B show (FIG. 2A) a diagram for the graphical representation of the armature stroke, and (FIG. 2B) a schematic longitudinal section through a gas valve during a first phase of the braking current application,

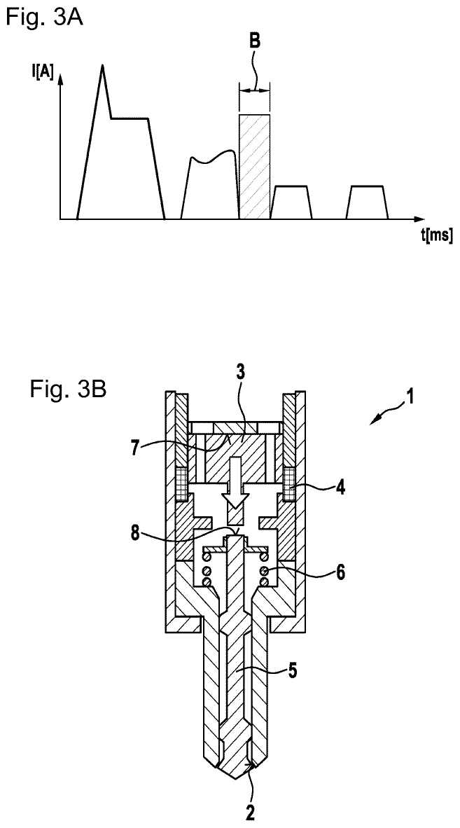

FIGS. 3A and 3B show (FIG. 3A) a diagram for the graphical representation of the armature stroke, and (FIG. 3B) a schematic longitudinal section through a gas valve during a second phase of the braking current application,

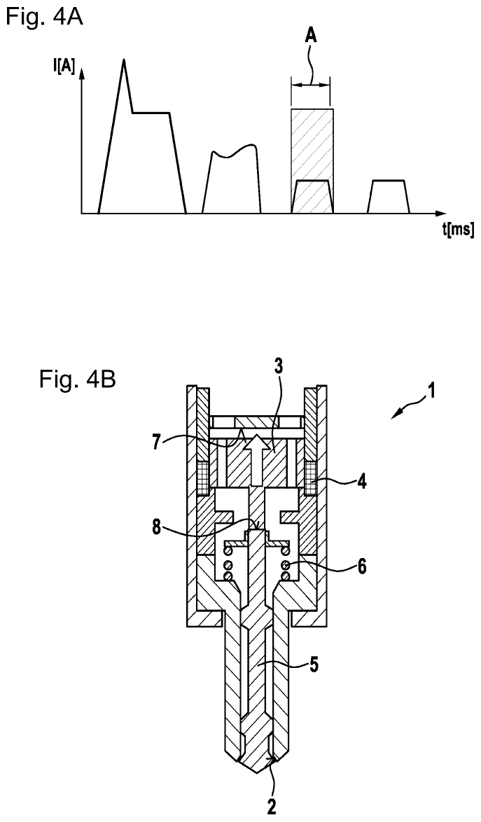

FIGS. 4A and 4B show (FIG. 4A) a diagram for the graphical representation of the armature stroke, and (FIG. 4B) a schematic longitudinal section through a gas valve during a third phase of the braking current application,

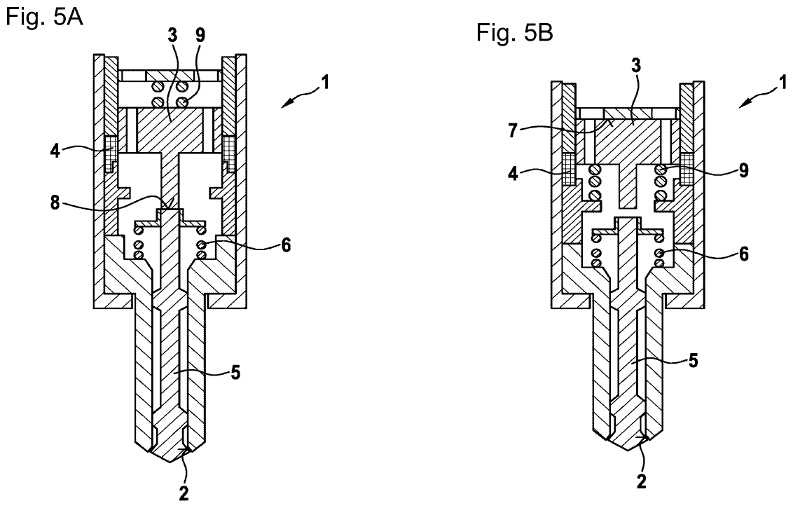

FIGS. 5A and 5B each show a schematic longitudinal section through a gas valve which can be controlled according to the method according to the present invention.

### DETAILED DESCRIPTION OF EXAMPLE EMBODIMENTS

The diagrams of FIG. 1A shows the current curve, FIG. 2B shows the voltage curve, and FIG. 1C shows the armature stroke during an opening and closing process of an electromagnetically controlled gas valve 1, as shown by way of example in FIGS. 2A to 5B. For opening, a solenoid coil 4 is first supplied with current, the magnetic force of which acts on an armature 3 so that the armature is pulled in the direction of the solenoid coil 4, wherein the armature 3 lifts a valve member 5 out of a seal seat 2 so that the gas valve 1 opens. The gas valve 1 is thus designed as a normally closed valve. Closing is brought about by means of a closing spring 6, by means of which the valve member 5 is preloaded in the direction of the seal seat 2 (see, by way of example, FIG. 2B).

For opening, the solenoid coil 4 is therefore first supplied with current, wherein the current supply comprises a boost phase for initial opening, an attraction phase for further opening, and a holding phase for keeping open (see FIG. 1A). In each phase, the current level is reduced. For closing, the current supply to the solenoid coil 4 is terminated so that the closing spring 6 returns the valve member 5 into the seal seat 2. In this case, the valve member 5 takes the armature 3 along. At time t₁, the valve member 5 is returned into the seal seat 2 so that, from this time, the armature 3 continues its movement alone and performs a free stroke h_{F} until it reaches a stop 7. Since the acceleration due to the spring force of the closing spring 6 is not applied, the armature 3 reduces its speed, which can be read from the current curve and/or voltage curve so that the closing time t₁ of the gas valve 1 can be detected on this basis.

When the stop 7 is reached at time t₂, so-called closing rebounds occur and the armature 3 reverses its direction of movement. This means that it again moves in the direction of the valve member 5, so that there is a risk that the gas valve 1 will open again. In this case, the valve member 5 forms a further stop 8 for the armature 3. This has the consequence that the direction of movement of the armature 3 is reversed again and the armature again moves in the direction of the stop 7. In FIG. 1C, the direction of movement of the armature 3 is reversed at each of the times t₂ to t₆. The change in the direction of movement can again be read from the current signal and/or voltage signal so that the armature movement can be detected by analyzing the control frequency. This is because, as can be seen from the voltage curve in FIG. 1B, the control frequency changes depending on the direction of movement of the armature 3.

The knowledge of the direction of movement of the armature 3 makes control of the gas valve 1 according to a method according to the present invention possible, which is explained below by way of example with reference to FIGS. 2A to 4B.

FIG. 2B first shows, by way of example, a gas valve 1 suitable for carrying out the method. This gas valve comprises a solenoid coil 4 for acting on an armature 3, which can be coupled to a valve member 5.

The valve member 5 is preloaded in the direction of a seal seat 2 by means of a closing spring 6.

FIG. 2A shows the current flow during an opening and closing process of the gas valve 1 of FIG. 2B. During the closing, after a current supply pause, a braking current phase A is initiated, which comprises a freewheeling phase. When the gas valve 1 closes, the armature 3 disengages from the valve member 5 and continues its movement alone until it reaches a stop 7 at time t₂. When the stop 7 is reached, which can be detected on the basis of the current curve, the braking current application is interrupted. The braking current phase A is thus followed by a current supply pause B. This is shown, by way of example, for the same gas valve 1 in FIGS. 3A and 3B. This is because, when the stop 7 is reached, the armature 3 reverses its direction of movement and now moves in the direction of the valve member 5 (see FIG. 3B). This valve member forms a further stop 8 so that the direction of movement is reversed again and the armature 3 again moves in the direction of the first stop 7. In order to decelerate the movement of the armature 3 again in this phase, the current supply pause B is followed by a new braking current phase A, as shown by way of example in FIGS. 4A and 4B. Since the armature 3 already moves significantly more slowly in the further braking current phase A, the current level can be reduced in comparison to the first braking current phase A. Depending on the movements of the armature 3, the phases can be repeated as often as desired.

The gas valve 1 shown in FIGS. 2A to 4B is selected only by way of example. The method according to the present invention can also be performed with other gas valves 1. Examples can be seen in FIGS. 5A and 5B. In FIG. 5A, the gas valve 1 has an additional armature spring 9, the spring force of which preloads the armature 3 in the direction of the valve member 5 or the lower stop 8. This means that, when opening the gas valve 1, the armature 3 already rests on the valve member 5 and does not have to perform a free stroke first. In FIG. 5B, the gas valve 1 10 likewise has an additional armature spring 9, which, however, preloads the armature 3 in the direction of the upper stop 7.

1-10. (canceled)

11. A method for controlling an electromagnetically controllable gas valve, the method comprising the following steps:
opening a seal seat by supplying with current a solenoid coil acting on an armature so that a valve member interacting with the seal seat is lifted out of the seal seat by the armature; and
closing the seal seat by terminating the current supply to the solenoid coil so that the valve member is returned into the seal seat by a spring force of a closing spring, the return of the valve member into the seal seat causing the armature to disengage from the valve member and perform a free stroke;
wherein a braking current is applied to the solenoid coil during the closing. and depending on a direction of movement of the armature, the current supply to the solenoid coil is interrupted and/or a current level is varied.

12. The method according to claim 11, wherein a control frequency analysis of a current signal and/or voltage signal is carried out in order to detect the direction of movement of the armature.

13. The method according to claim 11, wherein the braking current is only applied when the armature moves in a direction of a stop and/or reversal point remote from the seal seat, so that a braking current phase is followed by a current supply pause.

14. The method according to claim 13, wherein the current supply pause is followed by a new braking current phase when the armature has reached a stop and/or reversal point close to the seal seat.

15. The method according to claim 13, wherein braking current phases and current supply pauses alternate, a current level in each further braking current phase being selected to be at most equal to a current level of a preceding braking current phase.

16. The method according to claim 11, wherein the current level of the braking current is reduced when the armature has reached a stop and/or reversal point remote from the seal seat.

17. The method according to claim 16, wherein the current level of the braking current is increased again when the armature has reached the stop and/or reversal point close to the seal seat, a sensor current being used to detect the direction of movement of the armature.

18. The method according to claim 11, wherein, during a first braking current phase, the current level is continuously increased until a first target level is reached; when the first target level is reached, a freewheeling phase is initiated, in which a new target level for the braking current is defined which is at most identical to the first target level; and the freewheeling phase is terminated when the armature reverses its direction of movement, an extinction voltage being applied to terminate the freewheeling phase.

19. The method according to claim 18, wherein a closing time of the gas valve is detected by evaluating a current curve and/or voltage curve during the freewheeling phase.

20. A control device configured to control a gas valve, the control device configured to:
open a seal seat by supplying with current a solenoid coil acting on an armature so that a valve member interacting with the seal seat is lifted out of the seal seat by the armature; and
close the seal seat by terminating the current supply to the solenoid coil so that the valve member is returned into the seal seat by a spring force of a closing spring, the return of the valve member into the seal seat causing the armature to disengage from the valve member and perform a free stroke;
wherein a braking current is applied to the solenoid coil during the closing. and depending on a direction of movement of the armature, the current supply to the solenoid coil is interrupted and/or a current level is varied.
